(19) United States
(12) Patent Application Publication
(10) Pub. No.: US 2011/0269090 A1
(43) Pub. Date: Nov. 3, 2011

(54) DEVICE FOR TREATING A PRODUCT

(76) Inventors: Alfred Kunz, Muttenz (CH); Pierre Liechti, Muttenz (CH); Walther Schwenk, Kaiseraugst (CH); Bernhard Stuetzle, Riedisheim (FR)

(21) Appl. No.: 13/121,646

(22) PCT Filed: Sep. 28, 2009
(86) PCT No.: PCT/EP2009/006974

§ 371 Date: May 20, 2011

(30) Foreign Application Priority Data
Sep. 29, 2008 (DE) 10 2008 049 345.7
Feb. 26, 2009 (DE) 10 2009 010 393.7

(51) Int. Cl. F27D 3/00

(52) U.S. Cl. 432/239

(57) ABSTRACT

A device for treating a product that can be transported in a housing from an entry point to an exit point, particularly a torr factor for carrying out a roasting process utilizing a hardly flowable product forming nests and having no wall adhesion, wherein chambers are to be formed by disk-shaped elements disposed on a shaft.

### BACKGROUND OF THE INVENTION

The present invention relates to a device for treating a product which can be transported in a housing from an input to an application, in particular a roaster for carrying out a roasting process with a poorly flowing product which forms clusters and exhibits no wall adhesion.

Many products have to undergo a treatment process, for example a roasting process. In this particular case, a roaster is used. According to the prior art, the product to be roasted is transported in a friction-based method, e.g. by means of a worm shaft, through the various roasting chambers in the housing of the roaster. This is problematic in particular in the case of poorly flowing and bridge-forming products which form clusters and exhibit no wall adhesion. In the case of the abovementioned method there is the problem that targeted transporting of the product is prevented by the formation of clusters. Furthermore, the compacting and friction that inevitably occur in this method lead to the formation of dust and abrasion which should not be underestimated. In addition, there is always the risk of jamming points for the product occurring between the housing and the worm shaft.

It is the object of the present invention to provide a device of the abovementioned type for the controlled transport of a product in order to continuously carry out treatment processes.

### SUMMARY OF THE INVENTION

The object is achieved in that chambers are formed by disk-like elements which are arranged on a shaft.

A roaster as an example of a treatment device according to the invention is subdivided into a roasting and transporting zone and an output zone. The roasting and transporting zone is subdivided into a plurality of roasting chambers. Here, a biomass is subjected to pyrolysis, i.e. substantially in the absence of oxygen.

In principle, the roaster consists of a preferably cylindrical housing, with, however, any other housing forms being included in the concept of the invention, and a shaft which is driven is introduced into said housing. The concept of the invention is intended to include all possible configurations of the shaft, e.g. as a hollow shaft or with any desired profile.

Arranged on the shaft are disk-like plates or rings which form the roasting chambers. Preferably, the disks are welded to the shaft, but the concept of the invention also includes any other releasable or nonreleasable manners of fastening. A gap is formed between the disk and the housing, since the disks are configured with a smaller diameter than the housing. The disks, too, can be hollow and be heated by way of a heating medium.

The product is held in the roasting chamber for approximately 60% of a shaft rotation. Once a particular point has been exceeded, the product can drop freely into a space, which accounts for approximately 40% of a shaft rotation. When it falls freely, the product hits transporting elements which are arranged on the disks and protrude into the roasting chamber. The transporting elements are arranged and inclined in the transporting direction such that the product, when it hits a transporting element, is thrown through the gap between the disk and the housing and into the next chamber. Preferably, three transporting elements are welded to one disk, but any other number and manner of fastening is conceivable.

This simple configuration of the transporting elements has proven to be effective in the case of normal coarse-grained product, especially when these products stick together or form clusters. In this case, the product is lifted over the apex of the shaft and drops into a dropping zone in which the transporting elements or a collecting face of the transporting elements is positioned in the conveying direction, so that in this way the product is conveyed from an input to an output. However, many products are very fine-grained or considerable abrasion of a coarse-grained product forms in the housing of the device, this taking place substantially in the filling region. If the transporting elements attempt to lift this abrasion or these fine-grained products over the apex of the shaft, this is in many cases unsuccessful, and so the product drops off the transporting element while still in the filling region and hits a collecting face of the following transporting element. However, in this position of the curve, this collecting face is positioned in the opposite direction to the conveying direction and so, as a result, the product is transported counter to the conveying direction. This is extremely undesirable. In order to counteract this, special transporting elements have been developed. Essentially, these consist of an element for conveying by friction, said element being positioned opposite the collecting face (element for conveying by gravity). The corresponding elements can be arranged in a distributed manner on the circumference of the disk, but preferably they are arranged in a wedge-like manner with respect to one another, with the tip of the wedge pointing in the conveying direction. This has the advantage that in the dropping zone the element for conveying by gravity covers the element for conveying by friction which would be positioned in the “wrong” direction in the dropping zone. The same applies to the element for conveying by friction with respect to the element for conveying by gravity in the filling region.

Advantageously, the transporting elements are connected releasably to the disk, so that, depending on the product property, the optimum setting can be made. It is also conceivable that, although the transporting elements are firmly connected to the disk, different inclination angles and settings are possible depending on the product.

The product is thrown, as described above, out of the last roasting chamber and into the output zone. In the output zone, output elements in the form of a cell wheel are arranged on the disk. Here, transport only takes place in the radial direction, and no longer in the axial direction, along the shaft.

In principle, the free spaces within the roaster must be designed to be so large that product parts of the maximum size cannot form any cohesive clusters. As a result, it remains possible for the product to drop freely and thus to be transported in a targeted manner. All elements that allow product movement, circulation and transport are designed such that as little compacting and friction as possible is produced. This restricts the formation of dust and abrasion to a minimum, this being an important criterion for exhaust gas filtration. Jamming and pressing of the product between static and dynamic parts and thus comminution thereof must be ruled out in the entire product space. The regulated axial and radial distribution of the degree of filling produces the desired optimum gas space, which is calculated such that the gas streams do not entrain unnecessary quantities of dust. As a result, the deposition of solids is minimized.

### BRIEF DESCRIPTION OF THE DRAWINGS

Further advantages, features and details of the invention are given in the following description of preferred exemplary embodiments and with reference to the drawing, in which:

FIG. 1 shows a side view of a roaster according to the invention;

FIG. 2 shows a schematic section A-A corresponding to FIG. 1;

FIG. 3 shows a developed view of a shaft according to FIG. 1;

FIG. 4 shows a schematic section B-B corresponding to FIG. 1;

FIG. 5 shows a developed view of a shaft of a further exemplary embodiment of a roaster; and

FIG. 6 shows a side view of part of a developed view of the shaft according to FIG. 5.

### DETAILED DESCRIPTION

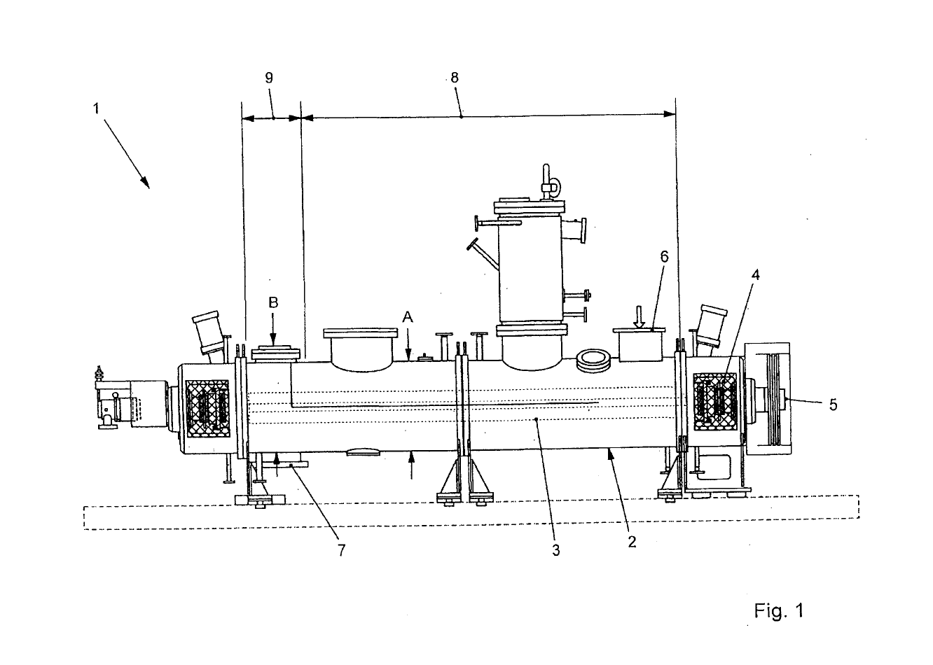

FIG. 1 shows a roaster 1. The housing 2 thereof is formed in a cylindrical manner. In said housing 2 there is located a shaft 3. The latter is rotated via a drive 4 about a central axis 5. Located on the housing 2 are an input 6 and an output 7. The input 6 is formed from an upwardly directed cylinder which is inserted into the housing 2 via an opening at the start of the housing 2, on the side of the drive 4. The output 7 is located on the other side of the housing 2. Said output 7 consists of a downwardly directed, cylindrical component which is inserted into the housing 2 via an opening.

The housing 2 is subdivided into a roasting and transporting zone 8 and an output zone 9. The roasting and transporting zone 8 begins at the input 6 and extends over a large part of the length of the housing 2 and the shaft 3. The output zone 9 directly adjoins the end of the roasting and transporting zone 8 and the output 7 is located thereunder.

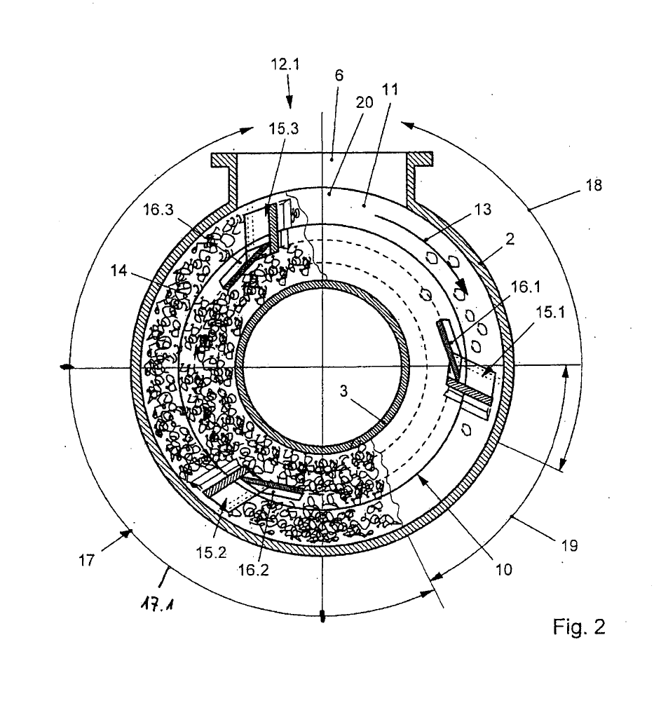

Arranged on the shaft 3 are disks 10. These are configured with a diameter which is larger than that of the shaft 3 and smaller than the inside diameter of the housing 2. As a result, there is a gap 11 between the disk 10 and the housing 2. The disks 10 subdivide the roasting and transporting zone 8 into a plurality of roasting chambers 12.1, 12.2, 12.3, etc. One roasting chamber 12.1 according to the invention is shown in FIG. 2 in a schematic section A-A through the housing 2 and the shaft 3 in the roasting and transporting zone 8. The roasting chamber 12.1 is in the form of a disk.

Arranged on the disk 10 in the roasting chamber 12.1 are transporting elements 15.1, 15.2 and 15.3. The transporting elements 15.1, 15.2, 15.3 protrude into the roasting chamber 12.1. Located on each transporting element 15 is a collecting face 16. These collecting faces 16.1, 16.2 and 16.3 on the transporting elements 15.1, 15.2 and 15.3 are inclined in the transporting direction out of the plane of the drawing in accordance with FIG. 2.

The functioning of the present invention is as follows:

At the start of the process, the shaft 3 is rotated in the rotational direction in accordance with the arrow 13 (see FIG. 2) about the central axis 5 via the drive 4. A product 14, which is preferably flowable and forms bridges or clusters and exhibits no wall adhesion, is introduced via the input 6.

The product 14 passes into the first roasting chamber 12.1 of the roasting and transporting zone 8 in accordance with FIG. 2. In the roasting chamber 12.1, this results in a filling region 17, a dropping zone 18 and a transporting region 19. Approximately the first 90° thereof can also be termed frictional zone 17.1, since powder abrasion takes place here on account of the interaction of the static housing 2 and the dynamic shaft 3, disks 10 and transporting elements 15. The angle of the filling region 17 is about 210°. The product 14 is held in this region for about 60% of a rotation of the shaft 3. Only once a high point 20 has been passed does the product 14 drop in the dropping zone 18. Dropping freely, the product 14 hits the collecting face 16.1 of the transporting element 15.1. By appropriately positioning the collecting face, the product 14 is thrown in a controlled manner through the gap 11 into the next roasting chamber 12.2. The transition into the next roasting chamber 12.1 takes place in the transporting region 19. This means that the product is actually conveyed while it drops.

In principle, care must be taken to prevent the product from being jammed and pressed, and comminuted in connection therewith, between the static and dynamic parts. The regulated axial and radial distribution of the degree of filling results in the desired optimum gas space, which is calculated such that the gas streams do not entrain unnecessary quantities of dust. This minimizes the deposition of fibrous material.

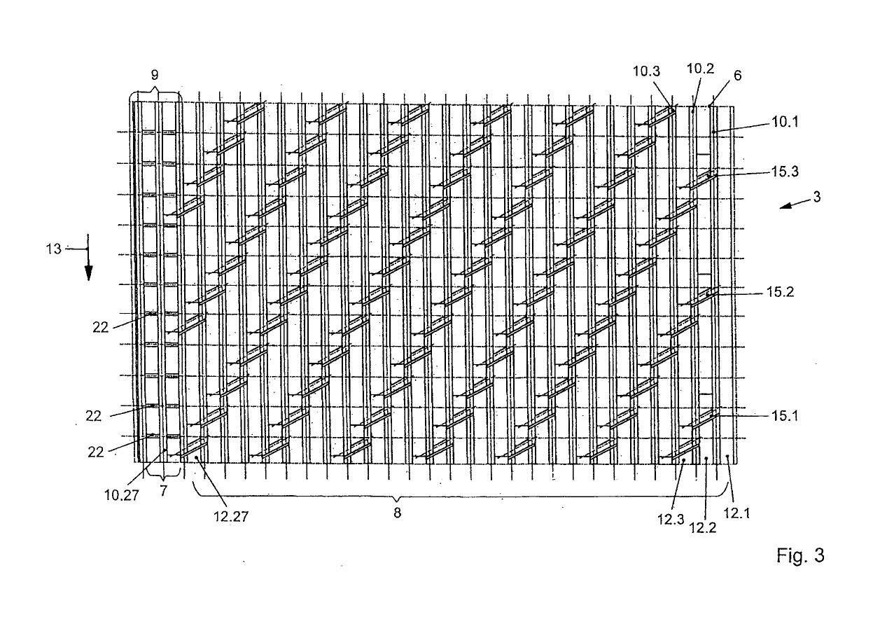

The arrangement of the roasting chambers 12.1, 12.2, 12.3 and 12.27 can be seen from the developed view 21 of the shaft in FIG. 3. The above-described sequence is repeated in a corresponding manner for all the roasting chambers of the roasting and transporting zone 8 that are shown in the developed view 21 of the shaft, the product 14 is thrown out of the final roasting chamber 12.27 into the output zone 9.

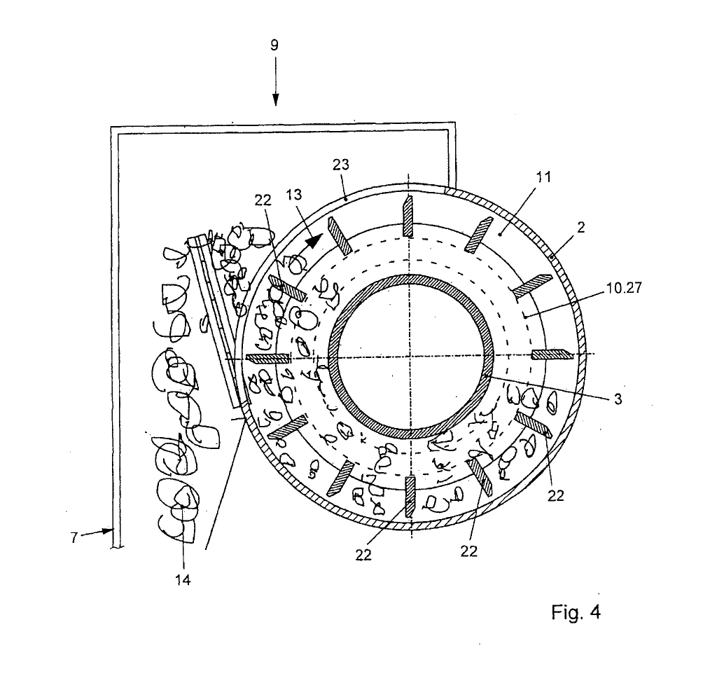

FIG. 4 shows a section B-B through the housing 2 and the shaft 3 in the output zone 9. In the output zone 9, output elements 22 are arranged on the disk 10.27 such that the output zone 9 is formed in the manner of a cell wheel. As a result, transport no longer takes place along the shaft 3 but only in the rotational direction 13 as far as an output opening 23. The product drops through the output opening out of the output zone 9 and the housing 2 of the roaster 1.

As previously in the roasting chambers, care must also be taken in the arrangement of the output elements 22 that no jamming points can arise in connection with an output opening 23. As a result the product 14 is not pressed but is output via the output in a loose manner without additional undesired abrasion which leads to the development of dust.

It can moreover be seen in FIG. 4 that the output or the output housing is actually located on the wrong side. The output 7 is positioned where the product rises. This means that the product is pushed and lifted by means of the output elements 22 and so no shearing or jamming, which is undesired in the case of a roasted product, takes place at all. For this purpose, the housing of the output 7 also extends as far as beyond the apex of the housing 2, resulting in a very large output opening in which likewise no jamming or shearing of the product can take place at all.

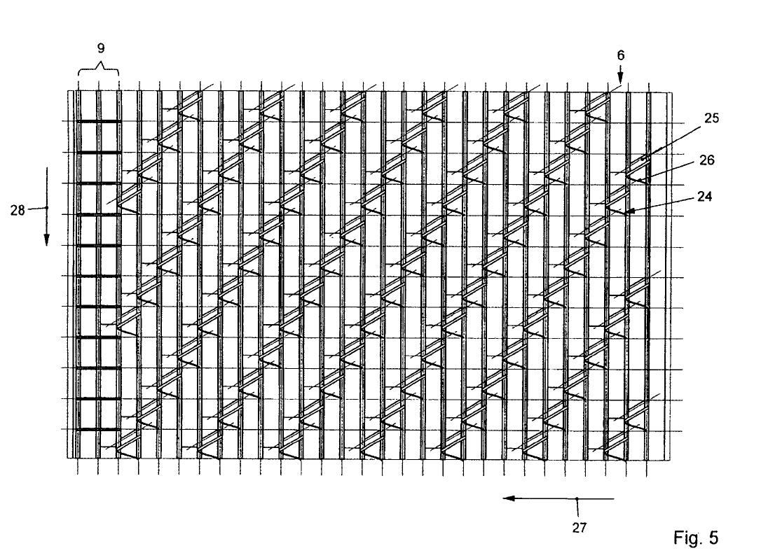

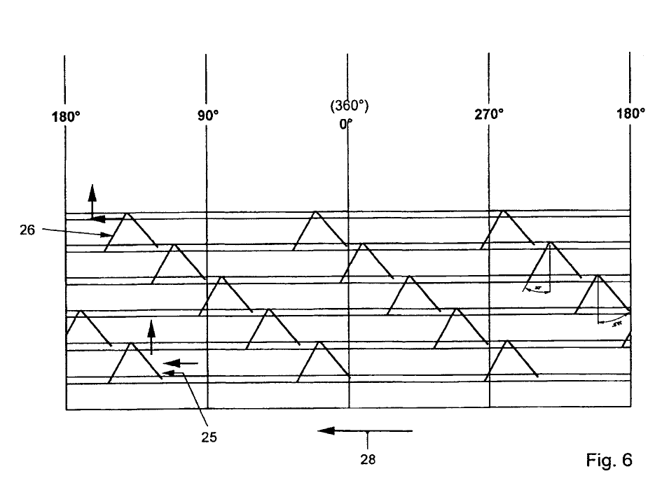

FIGS. 5 and 6 show a further developed view of a shaft of a further exemplary embodiment of a roaster. In practice, it has been found that the first exemplary embodiment works very well in the case of relatively coarse and heavy product, in particular when the product forms clusters. The product is in this case raised in a secure manner over the high point 20 and transported into the dropping zone 18 from where it is directed further in the transporting direction. However, difficulties arise in the case of relatively fine-grained products and in particular of course also in the case of abrasion of the otherwise properly transported products. These are not raised over the high point 20 by the transporting elements but repeatedly drop back in the filling region 17, especially onto following transporting elements 15 there. However, since these are now positioned counter to the dropping zone 18 or to the transporting region 19, these fine grains are transported counter to the desired transporting direction. This means that the shaft 3 conveys this abrasion backwards.

In order to prevent this, the transporting elements according to FIGS. 5 and 6 are designed in the form of a wedge. This means that each transporting element 24 is subdivided into an element 25 for conveying by gravity and an element 26 for conveying by friction, for example for powder-abrasion. This ensures that both the main product and also, for example, the abrasion thereof is transported in the conveying direction 27. The rotational direction is designated 28. It can be seen from the figures that the elements 25 for conveying by friction are placed “positively” with respect to the transporting direction and the rotational direction, whereas the elements 25 for conveying by gravity are placed “negatively” with respect to the transporting direction and the rotational direction.

1-20. (canceled)

21. A device for treating a product comprising a housing (2) having a product input (6) and a product output (7), a shaft (3) extending along an axis in the housing (2), a plurality of disk elements (10) arranged on the shaft (3) and spaced apart from each other to form a plurality of chambers (12.1, 12.2, 12.3, 12.27) between the disk elements (10).

22. The device as claimed in claim 21, wherein the disk elements (10) have a diameter greater than the shaft (3) diameter.

23. The device as claimed in claim 22, wherein in the disk elements (10) have a diameter smaller than the housing (2) inside diameter.

24. The device as claimed in claim 23, wherein a gap (11) is formed between the disk elements (10) and the housing (2).

25. The device as claimed in claim 24, wherein the housing defines a transport zone (8) and an output zone (9) and wherein a plurality of transporting elements (15, 24) are arranged on the disk elements (10) in the transport zone (8) and output zone (9).

26. The device as claimed in claim 25, wherein the transporting elements (15) have at least one collecting face (16, 25, 26).

27. The device as claimed in claim 26, wherein the at least one collecting face (16, 25) is inclined in a product transporting direction.

28. The device as claimed in claim 29, wherein the at least one collecting face (25) comprises an element (26) for conveying by friction.

29. The device as claimed in claim 28, wherein the at least one collecting face (25) and the element (26) for conveying by friction are arranged in a wedge manner with respect to one another.

30. The device as claimed in claim 29, wherein a tip of the wedge (24) points in the transport direction (27).

31. The device as claimed in claim 25, wherein the chambers (12.1, 12.2, 12.3, 12.27) have a filling region (17), a dropping zone (18) and a transporting region (19).

32. The device as claimed in claim 31, wherein a product (14) is held in the filling region (17) for approximately 60% of a rotation of the shaft (3).

33. The device as claimed in claim 31, wherein the product (14) drops in the dropping zone (18).

34. The device as claimed in claim 33, wherein the product (14) drops freely in the dropping zone (18), hits a collecting face (16) of a transporting element (15) on the disk elements, wherein the collecting face (16) is directed toward the output (7).

35. The device as claimed in claim 34, wherein, after hitting the collecting face (16), the product (14) is thrown through the gap (11) and into the next chamber.

36. The device as claimed in claim 24, wherein at least one output element (22) is arranged on one of the disk elements (10) located in the output zone (9).

37. the device as claimed in claim 36, wherein the at least one output element (22) is arranged in the output zone (9) in a manner corresponding to a cell radius.

38. The device as claimed in claim 37, wherein the output zone (9) and the output (7) are arranged at a position wherein the product is lifted by the at least one output element (22).
